(19) United States
(12) Patent Application Publication
(10) Pub. No.: US 2021/0334360 A1
(43) Pub. Date: Oct. 28, 2021

(54) METHOD FOR PROCESSING SANDBOX FILE IN QUEUE MANNER

(71) Applicants: Bluedon Information Security Technologies Corp., Guangzhou (CN); Bluedon Information Security Technologies Co., Ltd., Guangzhou (CN)

(72) Inventors: Zonggui Ke, Guangzhou (CN); Baoming Zhang, Guangzhou (CN); Xiaoning Qin, Guangzhou (CN)

(21) Appl. No.: 16/858,712

(22) Filed: Apr. 27, 2020

(51) Int. Cl. G06F 21/53; G06F 21/56

(52) U.S. Cl. CPC G06F 21/53; G06F 2221/033; G06F 21/565

(57) ABSTRACT

The present invention discloses a method for optimizing a sandbox. By changing a mode of the sandbox for processing a file, the present invention optimizes original pure database processing into database and file queue processing. The novel processing manner modifies an original behavior of the sandbox, reduces a load of a built-in database, and greatly reduces a probability of suspended animation of the sandbox.

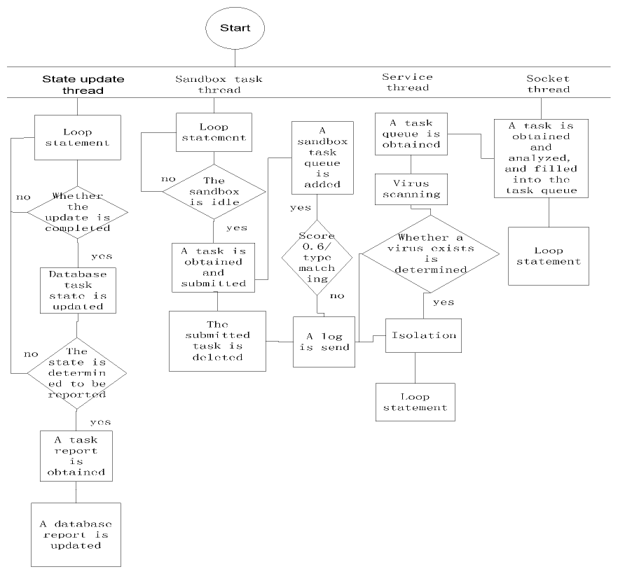

### TECHNICAL FIELD

The present invention relates to the field of a malicious file detection and processing, and in particular to a method for processing a sandbox file.

### BACKGROUND

With the continuous development of a computer technology, network security has become an issue that cannot be bypassed by information interconnection. In enterprise applications, it is not uncommon that multiple computers are connected to form a local area network. Since the local area network generally communicates with a service host, data can be freely transferred within the local area network. If one computer in the local area network is attacked by a malicious file, the security of the whole network is endangered. Particularly, when the service host or a gateway is attacked, the whole local area network can be completely paralyzed.

However, the local area network tends to have a large scale, and a network behavior of a host user cannot be monitored in each host, so traffic is detected generally by using a manner such as erecting a firewall at the gateway. At the same time, some isolation and protection measures may also be taken for a file in a network packet. And a sandbox is one of them.

The sandbox is a dynamic monitoring technology. By building a simulated computer environment, a malicious file and a code run in the simulated computer environment. Through hook program injection and event monitoring, a dynamic running condition of the malicious file is obtained. Then, a malicious degree of the file is determined according to these conditions. Based on these valid information, a malicious virus attacking the system can be screened from a large number of files.

One of application models uses a variety of virtual machine software as the simulation environment to simulate different operating systems, thus meeting the file detection under different platforms. A sandbox is generally composed of a host and a guest. Network communication is implemented by means of creating a Socket and binding a port. The sandbox builds a server on the guest and a client on the host, and transfers a command and data between the host and the guest through HOST and GET methods in the HTTP communication. The user may perform a sandbox file commit operation on a questionable file. Upon the reception of the committed file, the sandbox looks for a way to open the file, wakes up a corresponding application program by invoking a command line of the guest, and then injects a hook for monitoring. A monitoring result will be transferred to the host and recorded in a json file format. After that, the sandbox calculates the malicious degree of the file according to a j son file and a corresponding rule script.

Most existing sandboxes only use a pure database operation. A main program of the sandbox continuously reads a database and executes a file based on a database result. However, since the database bound to the sandbox is polymorphic, it is difficult to control a database used by a user, and a current state of a sandbox data table cannot be determined. Therefore, in case of suspended animation of a file task in operation, the entire sandbox system will be paralyzed. If the task is stopped by killing a sandbox process, the file needs to be resubmitted, the user experience is poor, and the instability also results in difficulty in industrial applications.

In order to solve the paralysis problem of the sandbox, and maintain continuous operation of a sandbox task chain, the present invention adopts a novel method for processing the file in a queue manner. With this method, the suspended animation of the sandbox basically disappears.

### SUMMARY

In order to overcome the shortages of the conventional art, the present invention monitors a state of a sandbox in real time by caching a task queue, and reasonably submits, according to an operation state of the sandbox and an operation state of a task, the task to the sandbox for processing. Moreover, the present invention optimizes a task processing content of the sandbox, and makes a detection according to a file type and a forward virus, thus further reducing the number of tasks of the sandbox.

The technical solutions of the present invention have the following beneficial effects:

The present invention reduces the number of times that a sandbox queries a database, and reduces the detection number of sandbox tasks. The present invention optimizes balanced allocation for multiple sandbox task in detection, and allocates the detection task reasonably at maximum. A JSON component is encapsulated and analyzed independently. The JSON supports multiple development languages, is convenient to be analyzed by a server, simple in database format and easy to read, and is a lightweight data switching format. In the technical solutions, as an intermediate transfer component, the present invention implements data encapsulation, type conversion and data analysis, implements data synchronization between any two databases, and has a very good expansibility.

### BRIEF DESCRIPTION OF THE DRAWINGS

In order to describe the technical solutions in the embodiments of the present invention or in the conventional art more clearly, a simple introduction on the accompanying drawings which are needed in the description of the embodiments or conventional art is given below. Apparently, the accompanying drawings in the description below are merely some of the embodiments of the present invention, based on which other drawings may be obtained by those of ordinary skill in the art without any creative effort.

The sole FIGURE is a flowchart of the present invention.

### DETAILED DESCRIPTION OF THE EMBODIMENTS

The technical solutions of the embodiments of the present invention are clearly and completely described below in combination with the accompanying drawings in the embodiments of the present invention, it is apparent that the described embodiments are only a part of embodiments of the present invention, instead of all the embodiments. All other embodiments obtained by a person of ordinary skill in the art based on the embodiments of the present invention without creative efforts shall pertain to the protection scope of the present invention.

Referring to the FIGURE, a method for synchronizing different modules is provided in a system, and includes the following steps:

1. An external program is connected to a sandbox optimization program by using a tcp socket, the external program performs protocol restoration and file restoration, and a JSON component is invoked to encapsulate data into a character string in a JSON format according to a self-defined format to send to the sandbox optimization program.

1.1 An external program is started to detect a protocol in real time, and perform protocol restoration and file restoration.

1.2 A JSON component is invoked to encapsulate data, a conversion type is a self-defined type, and a JSON character string is generated.

2. A tcp protocol is used to send the JSON character string to a sandbox optimization program via a socket.

3. The sandbox optimization program receives the character string via the socket by using the tcp protocol, invokes and analyzes the JSON component according to configuration information, analyzes the JSON character string, performs virus scanning, imports a sandbox task, recombines data and imports the data to a target database.

3.1 Upon the reception of the JSON character string, the sandbox optimization program invokes an analysis JSON component to analyze the data.

3.2 The sandbox optimization program obtains a parameter of a local configuration table.

3.3 The virus scanning is performed according to the parameter of the local configuration table.

3.4 The sandbox task is imported according to the parameter of the local configuration table.

3.5 The data is recombined, and imported to a corresponding target database.

The specific implementation steps are as follows:

1) Data collection and encapsulation: an external program detects a protocol in real time, and performs protocol restoration and file restoration; and then, data is converted into an internal format and encapsulated into a data packet in a JSON format.

a. A sending module is invoked to send the JSON data packet to a sandbox optimization receiving program.

2) Data allocation and analysis: the sandbox optimization receiving program invokes a JSON component to analyze the data packet, scans a virus and caches a sandbox task, recombines the received data, and imports the data to a target database.

a. The sandbox optimization receiving program monitors a specified port, and reads the JSON data packet.

b. A local configuration parameter is read.

c. The sandbox optimization receiving program invokes the JSON component, analyzes the data packet, scans the virus according to the local configuration parameter and caches the sandbox task.

d. The data is recombined, the target database is connected, and the data is imported.

For example:

1. PostgreSQL serves as a target database, and three statements imported by a sandbox optimization program to the target database are as follows:

SELECT file_id,task_id,\“source\”,filename,file_tran_time,md5,target FROM t_sandbox_process WHERE status !=‘ reported’ AND status !=‘ failed_analysis’;”

INSERT INTO t_sandbox_process (recordid,task_id,file_id,filename,target,status,source,date,file_tran_time,sandbox_num,md5) VALUES (“,”, “,”, “, ‘pending’,”, to_timestamp( ), to_timestamp( ), “,”);

update t_sandbox_process set status=“where task_id=” AND target=”;

2. The statements are encapsulated into a JSON data packet via a component.

{

“AppProto”: “HTTP”,
“Date”: “2018-01-2610: 23: 34”,
“TimeStamp”: 1516933414,
“Type”: “HTTP_File”,
“SrcIP”: “222.245.78.32”,
“SrcPort”: “80”,
“SrcMac”: “00-10-f3-51-40-3c”,
“DstIP”: “172.16.3.1”,
“DstPort”: “59168”,
“DstMac”: “80-f6-2e-87-14-1f”,
“Atts”: [

{

| | |
|---|---|
| “FileName”: | “ |

xe8x92x8bxe4xbbx8bxe7x9fxb3xe6x88x90xe8xb4xa5xe5xbdx95.xe5xbex90xe9xaax8fxe5x8
dx8e.xe6x89xabxe6x8fx8fxe7x89x88.PDF”,

“StorePath”:

“/var/suricata/audit/http/20180126/10/23/172.16.3.1_222.245.78.32_1516933413_91221_333
35_0x21750c00_2123718613_1398679260@.PDF”,

“FileSize”: 467961,
“FileId”:

“172.16.3.1_222.245.78.32_1516933413_91221_33335_0x21750c00_2123718613_1398679
260@”,

“FileType”: “pdf”

}

]

}

3. Upon analysis, a virus is scanned, the data is recombined and the data is encapsulated into the JSON data packet via a component.

{
“AppProto”: “HTTP”,
“Date”: “2018-02-12 11:29:47”,
“TimeStamp”: 1518406187,
“Type”: “HTTP_File”,
“SrcIP”: “220.181.15.150”,
“SrcPort”: “80”,
“SrcMac”: “00-90-0b-49-36-63”,
“DstIP”: “10.10.64.2”,
“DstPort”: “61213”,
“DstMac”: “40-8d-5c-b0-d7-ce”,
“Atts”: [

{

“FileName”: “mlofku7bmtYvor5XvvIhiYW5zaGnvvIkuZG9j?=”,
“StorePath”:

“/var/suricata/audit/http/20180212/ll/29/10.10.64.2_220.181.15.150_1518406186_853668_5
3978_0x7fffdadad6d0_971186243_1980331919@”,

“FileSize”: 89088,
“FileId”:

“10.10.64.2_220.181.15.150_1518406186_853668_53978_0x7fffdadad6d0_971186243_1980
331919@”,

“FileType”: “doc”

}

],
“Virus”: [

{

“VirusFileName”: “mlofku7bmtYvor5XvvIhiYW5zaGnvvIkuZG9j?=”,
“VirusFilePath”:

“/var/suricata/audit/http/20180212/ll/29/10.10.64.2_220.181.15.150_1518406186_853668_5
3978_0x7fffdadad6d0_971186243_1980331919@”,

“VirusDetectEngine”: “AI”,
“VirusName”: “-”,
“VirusType”: “-”,
“VirusLevel”: “low”,
“virusprobability”: “0.52”,
“VirusAction”: “[ACCEPT]”

}

]

}

The above gives a detailed introduction to a method for processing a sandbox file in a queue manner provided in the embodiments of the present invention. In the specification, a specific example is used to describe a principle and an implementation manner of the present invention. The description on the above embodiments is merely helpful to understand a method and a core concept of the present invention. Meanwhile, those of ordinary skill in the art may make a change within a scope of the specific implementation manners and applications according to a concept of the present invention. To sum up, the content in the specification should not be understood as a limit to the present invention.

What is claimed is:

1. A method for processing a sandbox file in a queue manner, comprising: starting an external program to detect a protocol in real time and to perform protocol restoration and file restoration; and invoking a JSON component to encapsulate data, a conversion type being a self-defined type, and generating a JSON character string.

2. The method for processing the sandbox file in the queue manner as claimed in claim 1, wherein a tcp protocol is used to send the JSON character string to a sandbox optimization program via a socket; and the sandbox optimization program receives the JSON character string via the socket by using the tcp protocol, invokes an analysis JSON component according to configuration information, to analyze the JSON character string, performs virus scanning, imports a sandbox task, recombines data and imports the data to a target database.

3. The method for processing the sandbox file in the queue manner as claimed in claim 1, wherein upon the reception of the JSON character string, the sandbox optimization program invokes an analysis JSON component to analyze the data; a sandbox optimization program obtains a parameter of a local configuration table; a virus is scanned according to the parameter of the local configuration table; a sandbox task is imported according to the parameter of the local configuration table; and the data is recombined, and imported to a corresponding target database.
